(19) United States
(12) Patent Application Publication
(10) Pub. No.: US 2018/0034106 A1
(43) Pub. Date: Feb. 1, 2018

(54) ELECTROLYTE FORMULATION FOR LITHIUM-ION BATTERIES

(71) Applicant: ARKEMA FRANCE, Colombes (FR)

(72) Inventor: Grégory SCHMIDT, Saint Andéol Le Château (FR)

(73) Assignee: ARKEMA FRANCE, Colombes (FR)

(21) Appl. No.: 15/551,446

(22) PCT Filed: Mar. 14, 2016
(86) PCT No.: PCT/FR2016/050559

§ 371 Date: Aug. 16, 2017

(30) Foreign Application Priority Data
Mar. 16, 2015 (FR) 1552122

(51) Int. Cl. H01M 10/0568; H01M 10/0525; H01M 10/0569

(52) U.S. Cl. CPC H01M 10/0568; H01M 10/0569; H01M 10/0525; H01M 2300/0037; H01M 2300/0034

(57) ABSTRACT

The invention concerns an electrolyte composition, comprising: —a lithium bis(fluorosulfonyl)imide salt and/or a lithium 4,5-dicyano-(trifluoromethyl) imidazolate salt; and —a solvent of formula (I): in which: —n is an integer of between 0 and 15, —R¹, R² and R³ represent, independently, a halogen atom or a C1 to C6 linear or branched alkyl group, —X represents either a covalent bond or a C1 to C6 linear or branched alkylene alkenylene or alkynylene group, —Y represents either an —(OCh₂Ch₂)m- group, or an —(N(CH₃)CH₂CH₂)m- group, m being an integer of between 0 and 15, provided that m is different from 0 when X represents a covalent bond, and —R⁴ represents a cyano, cyanate, isocyanate, thiocyanate or isothiocyanate group.

### FIELD OF THE INVENTION

The present invention relates to an electrolyte formulation based on a specific lithium salt, namely lithium bis(fluorosulfonyl)imide (LiFSI) and/or lithium 2-trifluoromethyl-4,5-dicarbonitrileimidazolate (LiTDI), in combination with a solvent of the silane type, and also to the use of this formulation in a Li-ion battery.

### TECHNICAL BACKGROUND

An elementary cell of a Li-ion storage battery (or lithium battery) comprises an anode (at discharge), generally made of lithium metal or based on carbon, and a cathode (at discharge), generally made of a lithium insertion compound of metal oxide type, such as LiMn₂O₄, LiCoO₂ or LiNiO₂. An electrolyte which conducts lithium ions is inserted between the anode and cathode. In the case of the cathode, the metal oxide is generally deposited on an aluminum current collector.

In the event of use, that is to say during the discharging of the battery, the lithium released by oxidation at the (−) pole by the anode in the ionic form Li⁺ migrates through the conducting electrolyte and will be inserted by a reduction reaction in the crystal lattice of the active material of the cathode at the (+) pole. The passage of each Li⁺ ion in the internal circuit of the battery is exactly compensated for by the passage of an electron in the external circuit, generating an electric current which can be used to supply various devices in the field of portable electronics, such as computers or telephones, or in the field of applications of greater power and energy density, such as electric vehicles.

The electrolyte generally consists of a lithium salt dissolved in a solvent, which is generally a mixture of organic carbonates, offering a good compromise between the viscosity and the dielectric constant. Additives can be added in order to improve the stability of the electrolyte salts.

The salt currently most widely used is the LiPF₆ salt; however, it exhibits numerous disadvantages, such as a limited thermal stability, an instability toward hydrolysis and thus a lower battery safety. On the other hand, it exhibits the advantage of forming a passivation layer on the aluminum and of having a high ionic conductivity.

Other salts, having the FSO₂⁻ group, have been proposed. They have demonstrated many advantages, in particular a better ionic conductivity and a resistance to hydrolysis. One of these salts, LiFSI (LiN(FSO₂)₂), has shown highly advantageous properties which make it a good candidate for replacing LiPF₆. LiFSI also forms a passivation layer, but more slowly and in a way which is highly sensitive to the purity of the product (see H-B. Han, J. Power Sources, 196, 3623-3632 (2011)).

Another salt has also been proposed, namely LiTDI (or lithium 2-trifluoromethyl-4,5-dicarbonitrileimidazolate). This salt exhibits the advantage of having fewer fluorine atoms and of having strong carbon-fluorine bonds, which makes it possible to prevent or reduce the formation of HF during the thermal or electrolytic decomposition of the salt. The document WO 2010/023413 shows that this salt exhibits a conductivity of the order of 6 mS/cm and a very good dissociation between the imidazolate anion and the lithium cation, hence its use as electrolyte salt for Li-ion batteries. On the other hand, the salt exhibits a high irreversible capacity without addition of additive for the formation of solid-electrolyte interphase (SEI) on the graphite.

Furthermore, the document US 2014/0356735 has shown the advantage of silane solvents in some electrolytes. The document illustrates in particular that the addition of the solvent to an electrolyte based on certain salts, such as LiPF₆, makes it possible to improve certain performance features of the Li-ion battery.

There exists a need to provide electrolytes making it possible to further improve the performance features of the Li-ion battery. There exists more particularly a need to provide electrolytes which make it possible to passivate (that is to say, to protect from corrosion) the cathode. There also exists a need to provide electrolytes which make it possible to reduce the irreversible capacity of the Li-ion battery.

### SUMMARY OF THE INVENTION

The invention relates first to an electrolyte composition comprising:
a lithium bis(fluorosulfonyl)imide salt and/or a lithium 2-trifluoromethyl-4,5-dicyanoim idazolate salt; and
un solvent de formula (I):

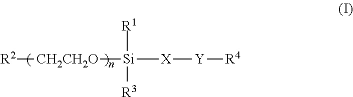

in which:
n is an integer having a value from 0 to 15,
R¹, R² and R³ independently represent a halogen atom or a linear or branched C₁ to C₆ alkyl group,
X represents either a covalent bond or a linear or branched C₁ to C₆ alkylene group, a linear or branched C₂ to C₆ alkenylene group or a linear or branched C₂ to C₆ alkynylene group,
Y represents either a —(OCH₂CH₂)ₘ— group or a —(N(CH₃)CH₂CH₂)ₘ— group, m being an integer having a value from 0 to 15, with the proviso that m is different than 0 when X represents a covalent bond, and
R⁴ represents a cyano, cyanate, isocyanate, thiocyanate or isothiocyanate group.

According to one embodiment, the solvent of formula (I) is more specifically of formula (II):

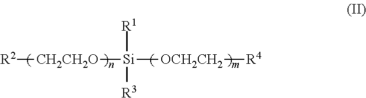

in which:
n and m are integers having values from 1 to 15,
R¹, R² and R³ independently represent a halogen atom or a linear or branched C₁ to C₆ alkyl group, and
R⁴ represents a cyano, cyanate, isocyanate, thiocyanate or isothiocyanate group.

According to one embodiment, the solvent of formula (I) is more specifically of formula (III):

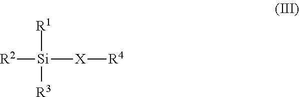

in which:
X represents either a covalent bond or a linear or branched C₁ to C₆ alkylene group, a linear or branched C₂ to C₆ alkenylene group or a linear or branched C₂ to C₆ alkynylene group,
R¹, R² and R³ independently represent a halogen atom or a linear or branched C₁ to C₆ alkyl group, and
R⁴ represents a cyano, cyanate, isocyanate, thiocyanate or isothiocyanate group.

According to one embodiment, the solvent of formula (I) is more specifically of formula (IV):

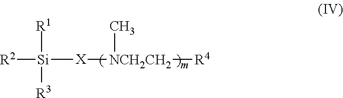

in which:
X represents either a covalent bond or a linear or branched C₁ to C₆ alkylene group, a linear or branched C₂ to C₆ alkenylene group or a linear or branched C₂ to C₆ alkynylene group,
m represents an integer having a value from 1 to 15,
R¹, R² and R³ independently represent a halogen atom or a linear or branched C₁ to C₆ alkyl group, and
R⁴ represents a cyano, cyanate, isocyanate, thiocyanate or isothiocyanate group.

According to one embodiment, the solvent of formula (I) is more specifically of formula (V):

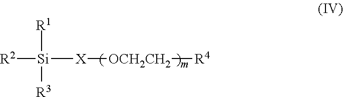

in which:
X represents either a covalent bond or a linear or branched C₁ to C₆ alkylene group, a linear or branched C₂ to C₆ alkenylene group or a linear or branched C₂ to C₆ alkynylene group,
m represents an integer having a value from 1 to 15,
R¹, R² and R³ independently represent a halogen atom or a linear or branched C₁ to C₆ alkyl group, and
R⁴ represents a cyano, cyanate, isocyanate, thiocyanate or isothiocyanate group.

According to one embodiment, the solvent of formula (I) is more specifically of formula (IIIa):

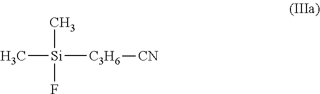

According to one embodiment, the concentration by weight of lithium bis(fluorosulfonyl)imide salt and/or lithium 2-trifluoromethyl-4,5-dicyanoimidazolate salt in the composition is from 0.5 to 16%.

According to one embodiment, the concentration by weight of solvent of formula (I) in the composition is from 0.5 to 5%.

According to one embodiment, the composition also comprises at least one additional solvent and preferably a mixture of two or three additional solvents chosen from carbonates, glymes, nitriles, dinitriles, fluorinated solvents and the combinations of these; and the composition more particularly preferably comprises a mixture of carbonates, such as a mixture of ethylene carbonate and diethyl carbonate.

According to one embodiment, the composition comprises another lithium salt preferably chosen from the LiPF₆, LiBF₄, CH₃COOLi, CH₃SO₃Li, CF₃SO₃Li, CF₃COOLi, Li₂B₁₂F₁₂ and LiBC₄O₈ salts.

According to one embodiment, the concentration by weight of other lithium salt is less than or equal to 15.5%.

Another subject matter of the invention is a battery comprising at least one cell which comprises a cathode, an anode and the electrolyte composition described above, interposed between the cathode and the anode.

The present invention makes it possible to overcome the disadvantages of the state of the art. It more particularly provides electrolytes conferring improved performance features on a Li-ion battery, in particular in terms of passivation of the cathode and in terms of decrease in the irreversible capacity of the battery.

This is accomplished by virtue of the use of a solvent of silane type in combination with a LiFSI or LiTDI lithium salt.

It has in particular been discovered that the use of a solvent of silane type in combination with LiFSI makes it possible to eliminate problems of corrosion due to impurities present in the LiFSI and, in the case of a LiFSI of high purity, to accelerate the formation of the passivation layer on the metal of the cathode. This passivation layer is essential for the proper operation of the Li-ion battery. This is because, without this layer, the capacity of the Li-ion battery would rapidly decrease during the operating time.

It has also been discovered that, in a case of LiTDI, the addition of solvent of silane type makes it possible to reduce the irreversible capacity of the Li-ion battery. The SEI, mentioned above, is a polymeric layer formed at the electrolyte/electrode interface during the first cycle. This SEI is essential for the operation of the battery and the quality of this SEI directly influences the lifetime of the battery. With the use of a solvent of silane type, a gain in irreversible capacity of several percent can be obtained.

### BRIEF DESCRIPTION OF THE FIGURES

FIG. 1 represents, with reference to example 1, the oxidation current (on the ordinate, in μA) as a function of the potential with regard to the Li/Li⁺ pair (on the abscissa, in V) in a Li-ion battery according to the invention (curves I) and in a comparative Li-ion battery (curves C).

### DESCRIPTION OF EMBODIMENTS OF THE INVENTION

The invention is now described in greater detail and in a nonlimiting manner in the description which follows.

All the proportions shown in the patent application are proportions by weight, unless otherwise mentioned.

The electrolyte of the invention comprises one or more lithium salts and one or more solvents.

The lithium salts include at least lithium bis(fluorosulfonyl)imide (LiFSI) or lithium 2-trifluoromethyl-4,5-dicyanoimidazolate (LiTDI). Use may also be made of a mixture of LiFSI and of LiTDI.

The total content of LiFSI and LiTDI is preferably from 0.5 to 16% by weight, with respect to the total electrolyte composition, more particularly preferably from 1 to 12% and in particular from 2 to 8%.

Other additional lithium salts can also be present. They can in particular be chosen from the LiPF₆, LiBF₄, CH₃COOLi, CH₃SO₃Li, CF₃SO₃Li, CF₃COOLi, Li₂B₁₂F₁₂ and LiBC₄O₈ salts.

The total content of additional lithium salts is preferably less than or equal to 16% by weight, with respect to the total composition, preferably less than or equal to 10%, or 5%, or 2%, or 1%.

Preferably, the LiFSI and/or LiTDI are predominant, by weight, among the total lithium salts of the electrolyte composition.

According to one embodiment, the sole lithium salt present in the electrolyte is LiFSI.

According to one embodiment, the sole lithium salt present in the electrolyte is LiTDI.

According to one embodiment, the sole lithium salts present in the electrolyte are LiFSI and LiTDI.

The molar concentration of lithium salts in the electrolyte can, for example, range from 0.01 to 5 mol/l, preferably from 0.1 to 2 mol/l and more particularly from 0.5 to 1.5 mol/l.

The molar concentration of LiFSI and/or LiTDI in the electrolyte can, for example, range from 0.01 to 5 mol/l, preferably from 0.1 to 2 mol/l and more particularly from 0.3 to 1.5 mol/l.

The electrolyte comprises one or more solvents. It comprises at least one silane solvent and preferably also one or more solvents which can in particular be organic carbonates, glymes, nitriles and/or fluorinated solvents.

The organic carbonates can in particular be chosen from ethylene carbonate, dimethyl carbonate, ethyl methyl carbonate, diethyl carbonate, propylene carbonate and the combinations of these.

The glymes can in particular be chosen from ethylene glycol dimethyl ether, diethylene glycol dimethyl ether, dipropylene glycol dimethyl ether, diethylene glycol diethyl ether, triethylamine glycol dimethyl ether, diethylene glycol dibutyl ether, tetraethylene glycol dimethyl ether, diethylene glycol t-butyl methyl ether and the combinations of these.

The nitriles (including dinitrile compounds) can in particular be chosen from acetonitrile, methoxypropionitrile, propionitrile, butyronitrile, isobutyronitrile, valeronitrile, malononitrile, succinonitrile, glutaronitrile and the combinations of these.

The fluorinated solvents can be carbonate, glyme or nitrile compounds described above, at least one hydrogen atom of which has been replaced by at least one fluorine atom.

Use may in particular be made, in the electrolyte composition, of a mixture of ethylene carbonate and of diethyl carbonate in a ratio by volume preferably ranging from 0.1 to 2, more particularly preferably from 0.2 to 1 and in particular from 0.3 to 0.5.

The silane solvent corresponds to the general formula (I):

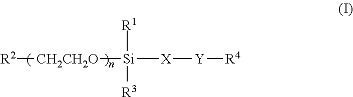

In this formula:
n is an integer having a value from 0 to 15,
R¹, R² and R³ independently represent a halogen atom or a linear or branched C₁ to C₆ alkyl group,
X represents either a covalent bond or a linear or branched C₁ to C₆ alkylene group, a linear or branched C₂ to C₆ alkenylene group or a linear or branched C₂ to C₆ alkynylene group,
Y represents either a —(OCH₂CH₂)ₘ— group or a —(N(CH₃)CH₂CH₂)ₘ— group, in which m is an integer having a value from 0 to 15, with the proviso that m is different than 0 when X represents a covalent bond, and
R⁴ represents a cyano, cyanate, isocyanate, thiocyanate or isothiocyanate group.

Preferably, n has a value from 0 to 10 or from 0 to 5 or from 0 to 2 or from 0 to 1. More particularly preferably, n has a value of 0 (that is to say that R² is connected to the Si atom by a single covalent bond).

Preferably, R¹, R² and R³ independently represent F or CH₃.

Preferably, X represents a C₁ to C₄ alkylene group and more particularly preferably a C₂ or C₃ alkylene group.

Preferably, m has a value from 0 to 10 or from 0 to 5 or from 0 to 2. More particularly preferably, Y represents a covalent bond (that is to say that m=0).

Preferably, R⁴ represents a cyano (—CN) group. Within the meaning of the general formula (I), the silane solvent can exhibit one of the more specific formulae (II) or (III) or (IV) or (V) below:

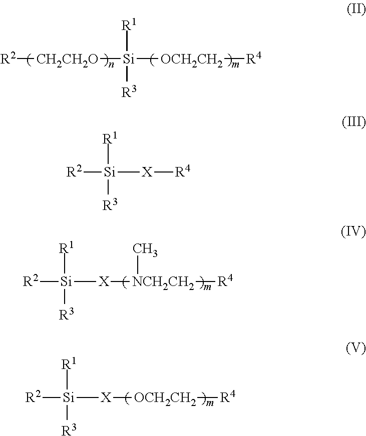

In these formulae (II) to (V), n, m, R¹, R², R³ and R⁴ have the same meanings (and the same preferred meanings) as above.

Preferably, in these formulae (II) to (V), n is greater than or equal to 1 and m is greater than or equal to 1.

Preferred compounds for the silane solvent are:
4-(trimethylsilyl)butanenitrile;
4-(fluorodimethylsilyl)butanenitrile;
4-(difluoromethylsilyl)butanenitrile;
4-(trifluorosilyl)butanenitrile;
3-(trimethylsilyl)butanenitrile;
3-(fluorodimethylsilyl)butanenitrile;
3-(difluoromethylsilyl)butanenitrile;
3-(trifluorosilyl)butanenitrile;
3-(trimethylsilyl)propanenitrile;
3-(fluorodimethylsilyl)propanenitrile;
3-(difluoromethylsilyl)propanenitrile; and
3-(trifluorosilyl)propanenitrile. 4-(Fluorodimethylsilyl)butanenitrile is very particularly preferred. This compound corresponds to the formula (IIIa):

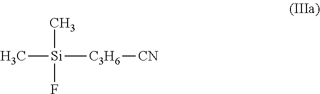

Combinations of two or more of the above silane solvents can be used.

The above silane solvents can be manufactured as described in the document US 2014/0356735.

The silane solvent is preferably employed in combination with another solvent, for example a mixture of organic carbonates. Preferably, the other solvent is predominant by volume with respect to the silane solvent.

The silane solvent can, for example, represent from 0.5 to 5% by weight, with respect to the total of the composition, in particular from 1 to 4% by weight.

A battery according to the invention comprises at least one cathode, one anode and one electrolyte interposed between the cathode and the anode.

The terms of cathode and anode are given with reference to the discharge mode of the battery.

According to one embodiment, the battery exhibits several cells which each comprise a cathode, an anode and an electrolyte interposed between the cathode and the anode. In this case, preferably, all of the cells are as described above in the summary of the invention. Furthermore, the invention also relates to an individual cell comprising a cathode, an anode and an electrolyte, the cathode and the electrolyte being as described above in the summary of the invention.

The cathode comprises an active material. The term “active material” is understood to mean a material into which the lithium ions resulting from the electrolyte are capable of being inserted and from which the lithium ions are capable of being released into the electrolyte.

Besides the active material, the cathode can advantageously comprise:
an electron-conducting additive; and/or
a polymer binder.

The cathode can be in the form of a composite material comprising the active material, the polymer binder and the electron-conducting additive.

The electron-conducting additive can, for example, be an allotropic form of carbon. Mention may in particular be made, as electron conductor, of carbon black, sp carbon, carbon nanotubes and carbon fibers.

The polymer binder can, for example, be a functionalized or nonfunctionalized fluoropolymer, such as polyvinylidene fluoride, or an aqueous-based polymer, for example carboxymethylcellulose, or a styrene/butadiene latex.

The cathode can comprise a metal current collector on which the composite material is deposited. This current collector can in particular be manufactured from aluminum.

The cathode can be manufactured as follows: All the abovementioned compounds are dissolved in an organic or aqueous solvent in order to form an ink. The ink is homogenized, for example using an Ultra-Turrax. This ink is subsequently laminated on the current collector and the solvent is removed by drying.

The anode can, for example, comprise lithium metal, graphite, carbon, carbon fibers, a Li₄Ti₅O₁₂ alloy or a combination of these. The composition and the method of preparation are similar to those of the cathode, with the exception of the active material.

### EXAMPLES

The following examples illustrate the invention without limiting it.

### Example 1

### Electrolyte Based on LiFSI

An electrolyte according to the invention is manufactured by dissolving, at ambient temperature, LiFSI at a concentration of 1 mol/l in a mixture of ethylene carbonate and diethyl carbonate in respective proportions by volume of 3 and 7. The solvent of formula (IIIa) above is added to this mixture in a proportion by weight of 2%, with respect to the total weight of the electrolyte. A second (comparative) electrolyte is prepared in the way but without the solvent of formula (IIIa).

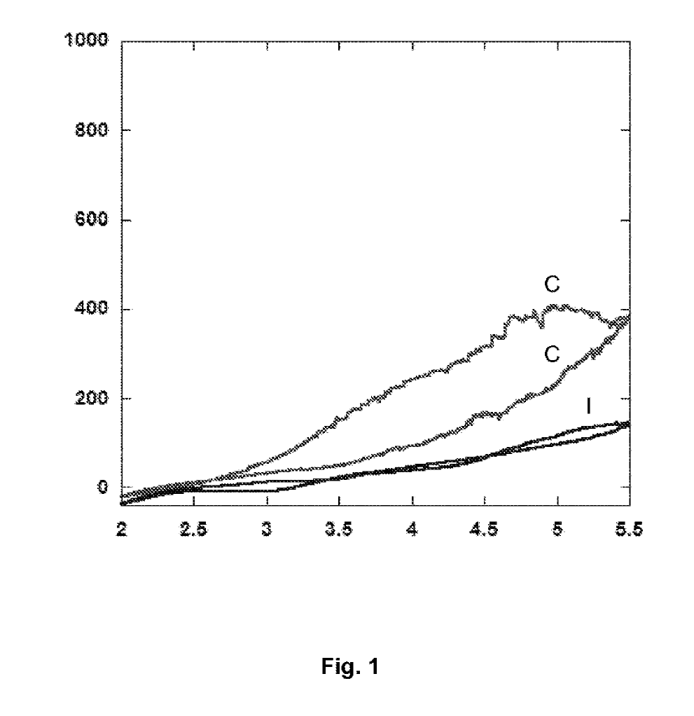

The passivation of aluminum of these two electrolytes is studied in a CR2032 button cell, with an aluminum foil at the cathode and lithium metal as reference at the anode. A separator made of glass fiber is impregnated with the electrolyte studied. A voltage sweep between 2 and 5.5 V is applied to the button cell with a sweep rate of 0.1 mV/s and the oxidation current is detected. FIG. 1 illustrates the effect of the addition of the silane solvent on the corrosion of the aluminum. It is found that the silane solvent reduces the corrosion of the aluminum.

### Example 2

### Electrolyte Based on LiTDI

An electrolyte according to the invention is manufactured by dissolving, at ambient temperature, LiTDI at a concentration of 1 mol/l in a mixture of ethylene carbonate and diethyl carbonate in respective proportions by volume of 3 and 7. The solvent of formula (IIIa) above is added to this mixture in a proportion by weight of 2%, with respect to the total weight of the electrolyte. A second (comparative) electrolyte is prepared in the same way but without the solvent of formula (IIIa).

The formation of the SEI of these two electrolytes is studied in a CR2032 button cell, with an electrode of graphite deposited on copper at the cathode and lithium metal as reference at the anode. A separator made of glass fiber is impregnated with the electrolyte studied. Each button cell is subjected to two charging/discharging phases at a C/24 rate (that is to say, a charging or discharging in 24 hours). For this, a negative current is applied during the charging and a positive current is applied during the discharging. The irreversible capacity is determined by taking the difference in capacity between the first and the second charging. This irreversible capacity has a value of:
21% with the comparative electrolyte without silane solvent; and
15% with the electrolyte of the invention with silane solvent.

Consequently, the capacity of the Li-ion battery is increased by 6% by virtue of the addition of the silane solvent to the electrolyte.

1. An electrolyte composition comprising:
a lithium bis(fluorosulfonyl)imide salt and/or a lithium 2-trifluoromethyl-4,5-dicyanoimidazolate salt; and
a solvent of formula (I): 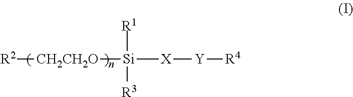
in which:
n is an integer having a value from 0 to 15,
R¹, R² and R³ independently represent a halogen atom or a linear or branched C₁ to C₆ alkyl group,
X represents either a covalent bond or a linear or branched C₁ to C₆ alkylene group, a linear or branched C₂ to C₆ alkenylene group or a linear or branched C₂ to C₆ alkynylene group,
Y represents either a —(OCH₂CH₂)ₘ— group or a —(N(CH₃)CH₂CH₂)ₘ— group, m being an integer having a value from 0 to 15, with the proviso that m is different than 0 when X represents a covalent bond, and
R⁴ represents a cyano, cyanate, isocyanate, thiocyanate or isothiocyanate group.

2. The composition as claimed in claim 1, wherein the solvent of formula (I) is more specifically of formula (II): 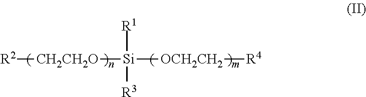
in which:
n and m are integers having values from 1 to 15,
R¹, R² and R³ independently represent a halogen atom or a linear or branched C₁ to C₆ alkyl group, and
R⁴ represents a cyano, cyanate, isocyanate, thiocyanate or isothiocyanate group.

3. The composition as claimed in claim 1, wherein the solvent of formula (I) is more specifically of formula (III): 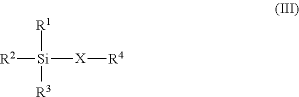
in which:
X represents either a covalent bond or a linear or branched C₁ to C₆ alkylene group, a linear or branched C₂ to C₆ alkenylene group or a linear or branched C₂ to C₆ alkynylene group,
R¹, R² and R³ independently represent a halogen atom or a linear or branched C₁ to C₆ alkyl group, and
R⁴ represents a cyano, cyanate, isocyanate, thiocyanate or isothiocyanate group.

4. The composition as claimed in claim 1, wherein the solvent of formula (I) is more specifically of formula (IV): 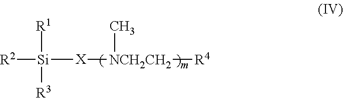
in which:
X represents either a covalent bond or a linear or branched C₁ to C₆ alkylene group, a linear or branched C₂ to C₆ alkenylene group or a linear or branched C₂ to C₆ alkynylene group,
m represents an integer having a value from 1 to 15,
R¹, R² and R³ independently represent a halogen atom or a linear or branched C₁ to C₆ alkyl group, and
R⁴ represents a cyano, cyanate, isocyanate, thiocyanate or isothiocyanate group.

5. The composition as claimed in claim 1, wherein the solvent of formula (I) is more specifically of formula (V): 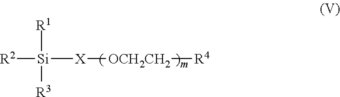
in which:
X represents either a covalent bond or a linear or branched C₁ to C₆ alkylene group, a linear or branched C₂ to C₆ alkenylene group or a linear or branched C₂ to C₆ alkynylene group,
m represents an integer having a value from 1 to 15,
R¹, R² and R³ independently represent a halogen atom or a linear or branched C₁ to C₆ alkyl group, and
R⁴ represents a cyano, cyanate, isocyanate, thiocyanate or isothiocyanate group.

6. The composition as claimed in claim 1, wherein the solvent of formula (I) is more specifically of formula (IIIa):

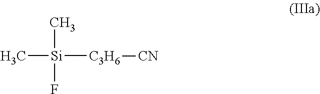

7. The composition as claimed in claim 1, wherein the concentration by weight of lithium bis(fluorosulfonyl)imide salt and/or lithium 2-trifluoromethyl-4,5-dicyanoimidazolate salt in the composition is from 0.5 to 16%.

8. The composition as claimed in claim 1, wherein the concentration by weight of solvent of formula (I) in the composition is from 0.5 to 5%.

9. The composition as claimed in claim 1, also comprising at least one additional solvent chosen from carbonates, glymes, nitriles, dinitriles, fluorinated solvents and the combinations of these.

10. The composition as claimed in claim 1, comprising another lithium salt.

11. The composition as claimed in claim 1, wherein the concentration by weight of other lithium salt is less than or equal to 15.5%.

12. A battery comprising at least one cell which comprises a cathode, an anode and the electrolyte composition as claimed in claim 1, interposed between the cathode and the anode.

13. The composition as claimed in claim 1, comprising another lithium salt chosen from the LiPF₆, LiBF₄, CH₃COOLi, CH₃SO₃Li, CF₃SO₃Li, CF₃COOLi, Li₂B₁₂F₁₂ and LiBC₄O₈ salts.
